(19) United States
(12) Patent Application Publication
(10) Pub. No.: US 2016/0006793 A1
(43) Pub. Date: Jan. 7, 2016

(54) OSD SUBJECT FILE OBTAINING AND PROVIDING METHOD AND DEVICE, UPDATING SYSTEM

(71) Applicants: BOE TECHNOLOGY GROUP CO., LTD., Beijing (CN); K-TRONICS (SU ZHOU) TECHNOLOGY CO., LTD., Suzhou, Jiansu Province (CN)

(72) Inventor: Xufeng WANG, Beijing (CN)

(21) Appl. No.: 14/770,645

(22) PCT Filed: Nov. 5, 2014
(86) PCT No.: PCT/CN2014/090392

§ 371 Date: Aug. 26, 2015

(30) Foreign Application Priority Data
Jul. 4, 2014 (CN) 201410318722.1

(51) Int. Cl. H04L 29/08

(52) U.S. Cl. CPC H04L 67/06; H04L 67/10

(57) ABSTRACT

An OSD subject file obtaining method and providing method, a digital television, a cloud sever and a OSD subject file updating system, by which the digital television obtains OSD subject files in real time from the cloud server through network. The OSD subject file obtaining method includes transmitting, by a digital television, to a cloud server a request instruction to access an OSD subject file library; accessing, by the digital television, the OSD subject file library on the cloud server through a link path established for the digital television by the cloud server according to the request instruction; selecting, by the digital television, at least one OSD subject file from the OSD subject file library; and obtaining, by the digital television, the OSD subject file selected by the digital television based on access path generated by the cloud server for each OSD subject file selected by the digital television.

### TECHNICAL FIELD OF THE DISCLOSURE

The present disclosure relates to an OSD subject file obtaining method and providing method, a digital television, a cloud sever and an OSD subject file updating system.

### BACKGROUND

Digital television is more and more popular currently and the user's demand on functions of the digital television is higher and higher. Different users may have different demand on interface subject of the digital television and thus there is proposed a method and a system for changing the subject of the function interface of the TV. In this method, a TV system invokes a grey image corresponding to the function interface, and an image reverting module of the TV system reverts the grey image to a colorful image according to a hue value of an objective skin color in a user's subject changing instruction. Although this method can achieve a purpose of changing On-Screen Display (OSD) subject in some degree, only the subject images which are built in the TV system can be selected and only the color of the subject images can be changed according to the hue value of the objective skin color, and content of the subject can not be changed.

Therefore, a current limited number of OSD subject files for the digital television can not satisfy the user's requirement of updating in real time.

### SUMMARY

There are provided an OSD subject file obtaining method and providing method, a digital television, a cloud sever and a OSD subject file updating system in the embodiments of the present disclosure, by which the digital television obtains OSD subject files in real time from the cloud server through network, to satisfy the user's requirement of updating current OSD subject files of the digital television in real time.

There is provided in one embodiment of the present disclosure a method for obtaining an OSD subject file, comprising: transmitting, by a digital television, to a cloud server a request instruction to access an OSD subject file library; accessing, by the digital television, the OSD subject file library on the cloud server through a link path established for the digital television by the cloud server according to the request instruction; selecting, by the digital television, at least one OSD subject file from the OSD subject file library; and obtaining, by the digital television, the OSD subject file selected by the digital television based on access path generated by the cloud server for each OSD subject file selected by the digital television.

According to the method for obtaining an OSD subject file provided in the embodiment of the present disclosure, in the case that a digital television is on-line, when it is determined that the OSD subject file needs to be obtained, the digital television obtains the selected OSD subject file in real time by accessing the OSD subject file library of the could server, so as to update the OSD subject file immediately, or store the selected OSD subject file which has been obtained. Therefore, the OSD subject file can also be updated in real time even if the digital television is off-line, which further solves the problem that the OSD subject file can not be updated in real time.

Optionally, the digital television includes a master and a remote controller, and said transmitting, by a digital television, to a cloud server a request instruction to access an OSD subject file library comprises: the master receiving an instruction to obtain the OSD subject file transmitted by the remote controller; and the master transmitting the request instruction to access the OSD subject file library to the cloud server in response to the instruction to obtain the OSD subject file.

Optionally, the digital television comprises a master and a remote controller, and said selecting, by the digital television, at least one OSD subject file from the OSD subject file library comprises: the master receiving a determination instruction transmitted from the remote controller; and the master transmitting a message for selecting the at least one OSD subject file from the OSD subject file library to the cloud server according to the determination instruction.

The digital television may select one OSD subject file or a plurality of OSD subject files when selecting the OSD subject file from the OSD subject file library.

Optionally, said obtaining, by the digital television, the OSD subject file selected by the digital television based on the access path generated by the cloud server for each OSD subject file selected by the digital television comprises: downloading, by the digital television, the OSD subject file through the access path generated by the cloud server for each OSD subject file selected by the digital television; and storing the downloaded OSD subject file to the digital television itself or to a storage device connected to the digital television.

The digital television can store the downloaded OSD subject files locally and update the OSD subject files immediately; or store the downloaded OSD subject files to the storage device connected thereto when it is detected that the storage device is connected to the digital television. Therefore, the OSD subject files can also be updated when the digital television is not connected with the network. Alternatively, the OSD subject files stored in the storage device can also be used for updating the OSD subject files of other digital televisions.

Optionally, the digital television comprises a master and a remote controller, and said storing the downloaded OSD subject file to the digital television itself or to the storage device connected to the digital television comprises: the master receiving a storage instruction transmitted from the remote controller; the master storing the downloaded OSD subject file locally or to the storage device connected to the master according to the storage instruction.

Optionally, the method further comprises: receiving, by the master, an OSD subject file browsing instruction transmitted from the remote controller and browsing the OSD subject files stored locally or in the storage device connected to the master according to the OSD subject file browsing instruction; and receiving, by the master, an OSD subject file updating instruction, selecting an OSD subject file to be updated from the OSD subject files stored locally or in the storage device connected to the master according to the OSD subject file updating instruction, and using the OSD subject file to be updated as a current OSD subject file of the digital television.

After obtaining the selected OSD subject file, in the case that the digital television is off-line, the master can browse the OSD subject files stored locally or in the storage device connected to the digital television at any time according to the OSD subject file browsing instruction received from the remote controller, and further selects the OSD subject file to be updated according to the OSD subject file updating instruction received from the remote controller, and uses the OSD subject file to be updated as the current OSD subject file of the digital television.

There is provided in an embodiment of the present disclosure a method for providing an OSD subject file, the method comprising: establishing, by a cloud server, a link path for a digital television according to an access request to access an OSD subject file library received from the digital television; generating, by the cloud server, a access path for each OSD subject file selected by the digital television according to an OSD subject file selecting instruction transmitted from the digital television through the link path; transmitting, by the cloud server, the access paths to the digital television through the link path so as to instruct the digital television to obtain the selected OSD subject file based on the access paths.

There is provided in another embodiment of the present disclosure a digital television, a master of which comprises: a requesting module configured to transmit to a cloud server a request instruction to access an OSD subject file library; an accessing module configured to access the OSD subject file library on the cloud server through a link path established for the digital television by the cloud server according to the request instruction; a selecting module configured to select at least one OSD subject file from the OSD subject file library; and an obtaining module configured to obtain the selected OSD subject file based on access path generated by the cloud server for each selected OSD subject file.

According to the digital television provided in the present embodiment, in the case that a digital television is on-line, when it is determined that the OSD subject file needs to be obtained, the digital television obtains the selected OSD subject file in real time by accessing the OSD subject file library of the could server, so as to update the OSD subject file immediately, or store the selected OSD subject file which has been obtained. Therefore, the OSD subject file can also be updated in real time even if the digital television is off-line, which further solves the problem that the OSD subject file can not be updated in real time.

Optionally, the digital television further comprises a remote controller, wherein the remote controller is configured to transmit an instruction to obtain the OSD subject file to the master, and the requesting module is particularly configured to: receive the instruction to obtain the OSD subject file transmitted by the remote controller; and transmit the request instruction to access the OSD subject file library to the cloud server in response to the instruction to obtain the OSD subject file.

Optionally, the remote controller is configured to transmit, to the master, a determination instruction for instructing the master to transmit, to the cloud server, a message for selecting at least one OSD subject file from the OSD subject file library, and the selecting module is particularly configured to: receive the determination instruction transmitted from the remote controller; and transmit the message for selecting the at least one OSD subject file from the OSD subject file library to the cloud server according to the determination instruction.

Optionally, the remote controller is configured to transmit to the master a storage instruction for instructing the master to store the downloaded OSD subject file locally to the master or to a storage device connected to the master.

The obtaining module, when storing the downloaded OSD subject file locally to the master or to a storage device connected to the master, is particularly configured to: download the OSD subject file based on the access path generated by the cloud server for each OSD subject file selected by the digital television; and store the downloaded OSD subject file locally to the master or to a storage device connected to the master.

Optionally, the obtaining module, when storing the downloaded OSD subject file locally to the master or to the storage device connected to the master, is in particular configured to: receive the storage instruction transmitted from the remote controller; and store the downloaded OSD subject file locally to the master or to the storage device connected to the master according to the storage instruction.

Optionally, the remote controller is configured to transmit to the master an OSD subject file browsing instruction and an OSD subject file updating instruction, and the master further comprises an updating module which is configured to: receive the OSD subject file browsing instruction transmitted from the remote controller and browsing the OSD subject files stored locally in the master or in the storage device connected to the master according to the OSD subject file browsing instruction; and receive the OSD subject file updating instruction transmitted from the remote controller, selecting a OSD subject file to be updated from the OSD subject files stored locally in the master or in the storage device connected to the master according to the OSD subject file updating instruction, and using the OSD subject file to be updated as a current OSD subject file of the digital television.

There is provided in another embodiment a cloud server comprising: a link path establishing module configured to establish a link path for a digital television according to an access request to access an OSD subject file library received from the digital television; an access path generating module, configured to generate an access path for each OSD subject file selected by the digital television according to an OSD subject file selecting instruction transmitted from the digital television through the link path; and a transmitting module configured to transmit the access paths to the digital television through the link path so as to instruct the digital television to obtain the selected OSD subject file based on the access paths.

There is provided in another embodiment of the disclosure a system for updating an OSD subject file, the system comprising at least one cloud server as described above and the digital television as described above.

### BRIEF DESCRIPTION OF THE DRAWINGS

FIG. 1 illustrates an OSD subject file obtaining method provided in an embodiment of the present disclosure;

FIG. 2 illustrates another OSD subject file obtaining method provided in an embodiment of the present disclosure;

FIG. 3 illustrates an OSD subject file providing method provided in an embodiment of the present disclosure;

FIG. 4 illustrates a digital television provided in an embodiment of the present disclosure;

FIG. 5 illustrates a cloud server provided in an embodiment of the present disclosure; and

FIG. 6 illustrates an OSD subject file updating system provided in an embodiment of the present disclosure.

### DETAILED DESCRIPTION

There are provided an OSD subject file obtaining method and providing method, a digital television, a cloud sever and a OSD subject file updating system in the embodiments of the present disclosure, by which the digital television obtains OSD subject files in real time from the cloud server through network, to satisfy the user's requirement of updating current OSD subject files of the digital television in real time.

A clear and complete description of the technical solutions of the embodiments of the present disclosure will be described with reference to the drawings in the embodiments. Obviously, the embodiments described herein are only part of, but not all of, the embodiments of the present disclosure. Based on the embodiments of the present disclosure, all other embodiments obtained by those ordinary skilled in the art without creative effort belong to the protection scope of the present disclosure.

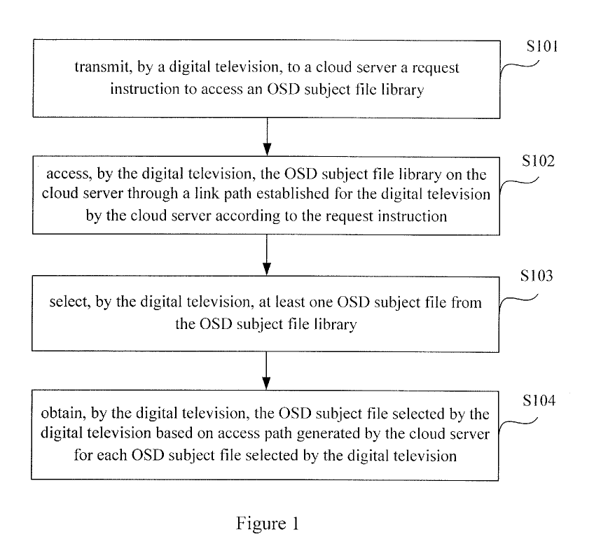

With reference to FIG. 1, in an embodiment of the present disclosure, there is provided a method for obtaining an OSD subject file comprising:

Step S101: transmitting, by a digital television, to a cloud server a request instruction to access an OSD subject file library;

Step S102: accessing, by the digital television, the OSD subject file library on the cloud server through a link path established for the digital television by the cloud server according to the request instruction;

Step S103: selecting, by the digital television, at least one OSD subject file from the OSD subject file library; and

Step S104: obtaining, by the digital television, the OSD subject file selected by the digital television based on access path generated by the cloud server for each OSD subject file selected by the digital television.

According to the method for obtaining an OSD subject file provided in the embodiment of the present disclosure, in the case that a digital television is on-line, when it is determined that the OSD subject file needs to be obtained, the digital television obtains the selected OSD subject file in real time by accessing the OSD subject file library of the could server, so as to update the OSD subject file immediately, or store the selected OSD subject file which has been obtained. Therefore, the OSD subject file can also be updated in real time even if the digital television is off-line, which further solves the problem that the OSD subject file can not be updated in real time.

Generally, the digital television includes a master and a remote controller, and thus the following description is given in the example that the digital television includes the master and the remote controller. Of course, this is only an example, and digital television may not include the remote controller and then the functional operations of the remote controller can be implemented by operational buttons on the master.

In step S101, said transmitting, by the digital television, to the cloud server the request instruction to access the OSD subject file library includes: the master receiving an instruction to obtain the OSD subject file transmitted by the remote controller; and the master transmitting the request instruction to access the OSD subject file library to the cloud server in response to the instruction to obtain the OSD subject file.

The remote controller determines to transmit the instruction for obtaining the OSD subject file to the master according to the user's requirement. Therefore, the OSD subject file library on the cloud server is accessed according to the user's requirement so as to further select the OSD subject file according to the user's preference, which improves the user's experience.

In step S103, said selecting, by the digital television, at least one OSD subject file from the OSD subject file library includes: the master receiving a determination instruction transmitted from the remote controller; and the master transmitting a message for selecting the at least one OSD subject file from the OSD subject file library to the cloud server according to the determination instruction.

The digital television may select one OSD subject file or a plurality of OSD subject files when selecting the OSD subject file from the OSD subject file library.

In step S104, said obtaining, by the digital television, the OSD subject files selected by the digital television based on access path generated by the cloud server for each OSD subject file selected by the digital television includes: downloading, by the digital television, the OSD subject file through the access path generated by the cloud server for each OSD subject file selected by the digital television; and storing the downloaded OSD subject file to the digital television itself or to a storage device connected to the digital television.

The digital television can store the downloaded OSD subject files locally and update the OSD subject files immediately; or store the downloaded OSD subject files to the storage device connected thereto when it is detected that the storage device is connected to the digital television. Therefore, the OSD subject files can also be updated when the digital television is not connected with the network. Alternatively, the OSD subject files stored in the storage device can also be used for updating the OSD subject files of other digital televisions.

In the practice, the user can download one or more OSD subject file every time as he/she likes. When downloading one OSD subject file, the updating can be performed in real time immediately after the OSD subject file is obtained. When downloading a plurality of favorite OSD subject files, a most favorite one can be selected so as to perform updating immediately and others can be stored in the storage device for performing update again, or the OSD subject files stored in the storage device can be used to update the OSD subject file of other digital televisions.

In specific, in step S104, said storing the downloaded OSD subject file to the digital television itself or to the storage device connected to the digital television includes: the master receiving a storage instruction transmitted from the remote controller; the master storing the downloaded OSD subject files locally or to the storage device connected to the digital television according to the storage instruction.

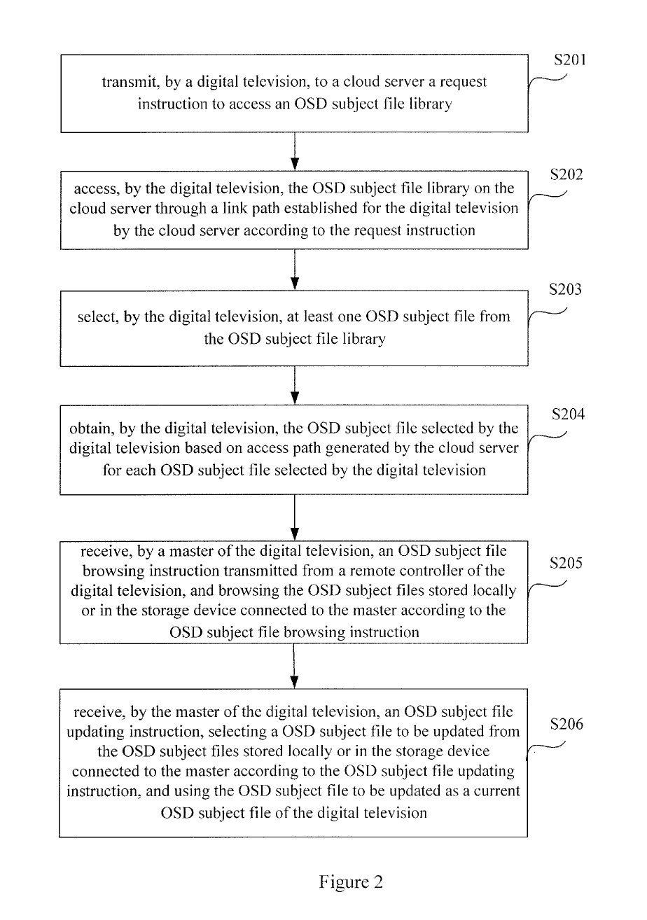

In a preferred embodiment, since the OSD subject file of the digital television needs to be updated by using the obtained OSD subject file after it is obtained, there is provided another method for obtaining the OSD subject file in an embodiment of the present disclosure as shown in FIG. 2, the method includes:

Step S201: transmitting, by a digital television, to a cloud server a request instruction to access an OSD subject file library;

Step S202: accessing, by the digital television, the OSD subject file library on the cloud server through a link path established for the digital television by the cloud server according to the request instruction;

Step S203: selecting, by the digital television, at least one OSD subject file from the OSD subject file library;

Step S204: obtaining, by the digital television, the OSD subject file selected by the digital television based on access path generated by the cloud server for each OSD subject file selected by the digital television;

Step S205: receiving, by a master of the digital television, an OSD subject file browsing instruction transmitted from a remote controller of the digital television, and browsing the OSD subject files stored locally or in the storage device connected to the master according to the OSD subject file browsing instruction; and

Step S206, receiving, by the master of the digital television, an OSD subject file updating instruction, selecting a OSD subject file to be updated from the OSD subject files stored locally or in the storage device connected to the master according to the OSD subject file updating instruction, and using the OSD subject file to be updated as a current OSD subject file of the digital television.

That is to say, after obtaining the selected OSD subject file, it can be chosen to perform updating immediately, that is, browse the OSD subject files stored locally in the master or in the storage device connected to the master according to the OSD subject file browsing instruction received from the remote controller, further select the OSD subject file to be updated according to the OSD subject file updating instruction received from the remote controller, and use the OSD subject file to be updated as the current OSD subject file of the digital television.

Of course, after obtaining the selected OSD subject file, it can be chosen not to perform the update of the OSD subject file immediately, but to perform the update subsequently when there exists a requirement of updating the OSD subject file.

It is to be noted that in the practice, the OSD subject file includes OSD global information and window information, and data of the OSD subject file and logical codes are independent of each other. It is because that if the OSD data of the subject file are written in the logical codes of the system, then the users can not install favorite subjects according to their preference but can only depend on the system itself.

Furthermore, after obtaining the OSD subject file, the digital television generates a digital television OSD graphic interface by parsing the OSD subject file, packages commonly used controls, such as controls commonly used on menu interface, signal source interface, channel managing interface or the like, and finally displays a subject interface corresponding to the updated OSD subject file on the digital television. This process may employ the existing techniques, and thus the detailed description is omitted.

The method for obtaining the OSD subject file at the digital television side according to one embodiment of the present disclosure has been described above, and a method for providing the OSD subject file at the cloud server side according to another embodiment of the present disclosure will be described below.

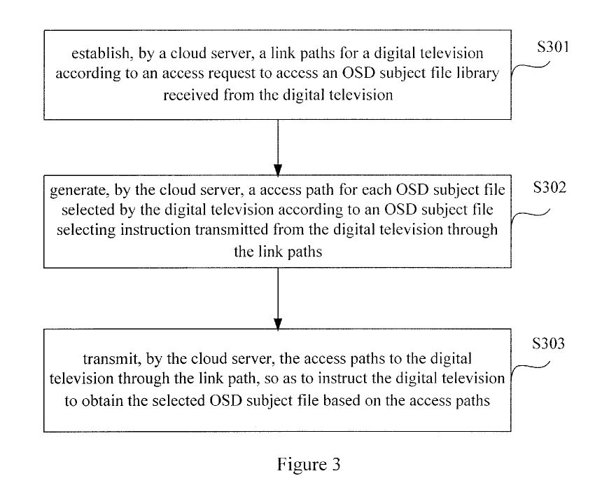

As shown in FIG. 3, there is provided another method for providing an OSD subject file in an embodiment of the present disclosure, which includes:

Step S301, establishing, by a cloud server, a link paths for a digital television according to an access request to access an OSD subject file library received from the digital television;

Step S302, generating, by the cloud server, a access path for each OSD subject file selected by the digital television according to an OSD subject file selecting instruction transmitted from the digital television through the link paths;

Step S303, transmitting, by the cloud server, the access paths to the digital television through the link path, so as to instruct the digital television to obtain the selected OSD subject file based on the access paths.

In the practice, the cloud server may store different OSD subject file libraries for different types of digital televisions and continuously update the various OSD subject file libraries, so that the cloud server can provide various OSD subject files for the digital television to select when any of the digital televisions requires updating the OSD subject files.

The method for providing the OSD subject file according the present embodiment enables the digital television to update the OSD subject file in real time.

The methods for obtaining and providing the OSD subject file according the embodiments of the present disclosure have been described above in detail, and the devices provided in the embodiments of the present disclosure will be described below.

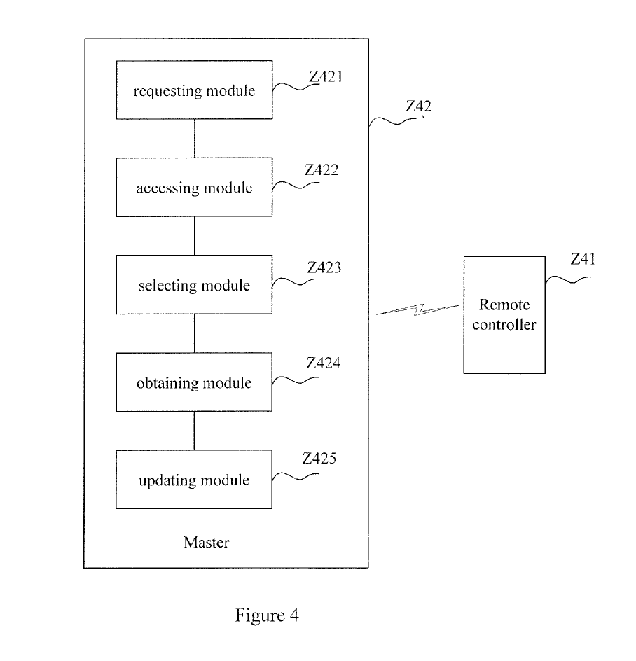

As shown in FIG. 4, there is provided a digital television in an embodiment of the present disclosure, which includes a master Z42 and a remote controller 41, wherein the master 42 includes:

a requesting module Z421, configured to transmit to a cloud server a request instruction to access an OSD subject file library;

a accessing module Z422, configured to access the OSD subject file library on the cloud server through a link path established for the digital television by the cloud server according to the request instruction;

a selecting module Z423, configured to select at least one OSD subject file from the OSD subject file library; and

an obtaining module Z424, configure to obtain the selected OSD subject file based on access path generated by the cloud server for each selected OSD subject file.

According to the digital television provided in the present embodiment, in the case that a digital television is on-line, when it is determined that the OSD subject file needs to be obtained, the digital television obtains the selected OSD subject file in real time by accessing the OSD subject file library of the could server, so as to update the OSD subject file immediately, or store the selected OSD subject file which has been obtained. Therefore, the OSD subject file can also be updated in real time even if the digital television is off-line, which further solves the problem that the OSD subject file can not be updated in real time

In the practice, the remote controller Z41 is used for transmitting an instruction to obtain the OSD subject file to the master. The requesting module Z421 transmits to the cloud server a request instruction to access the OSD subject file library when it is determined that the OSD subject files needs to be obtained, and is in particular used for: receiving the instruction to obtain the OSD subject file transmitted by the remote controller; and transmitting the request instruction to access the OSD subject file library to the cloud server in response to the instruction to obtain the OSD subject file.

In the practice, the remote controller Z41 is used for transmitting to the master Z42 a determination instruction to instruct the master to transmit, to the cloud server, a message for selecting at least one OSD subject file from the OSD subject file library. The selecting module Z423, when selecting the at least one OSD subject file from the OSD subject file library, is in particular used for: receiving the determination instruction transmitted from the remote controller; and transmitting the message for selecting the at least one OSD subject file from the OSD subject file library to the cloud server according to the determination instruction.

In the practice, the remote controller Z41 is used for transmitting to the master Z42 a storage instruction for instructing the master to store the downloaded OSD subject file locally to the master or to a storage device connected to the master Z42.

The obtaining module Z424, when storing the downloaded OSD subject file locally to the master or to the storage device connected to the master, is in particular used for: downloading the OSD subject file based on the access path generated by the cloud server for each OSD subject file selected by the digital television; and storing the downloaded OSD subject files locally to the master or to the storage device connected to the master.

In the practice, the obtaining module Z424, when storing the downloaded OSD subject file locally to the master or to the storage device connected to the master, is in particular used for: receiving the storage instruction transmitted from the remote controller; and storing the downloaded OSD subject file locally to the master or to the storage device connected to the master according to the storage instruction.

In the practice, the remote controller Z41 may be further used for transmitting to the master Z42 an OSD subject file browsing instruction and an OSD subject file updating instruction.

As shown in FIG. 4, the master Z42 further includes a updating module Z425 which is used for: receiving the OSD subject file browsing instruction transmitted from the remote controller and browsing the OSD subject files stored locally in the master or in the storage device connected to the master according to the OSD subject file browsing instruction; and receiving the OSD subject file updating instruction transmitted from the remote controller, selecting a OSD subject file to be updated from the OSD subject files stored locally in the master or in the storage device connected to the master according to the OSD subject file updating instruction, and using the OSD subject file to be updated as a current OSD subject file of the digital television.

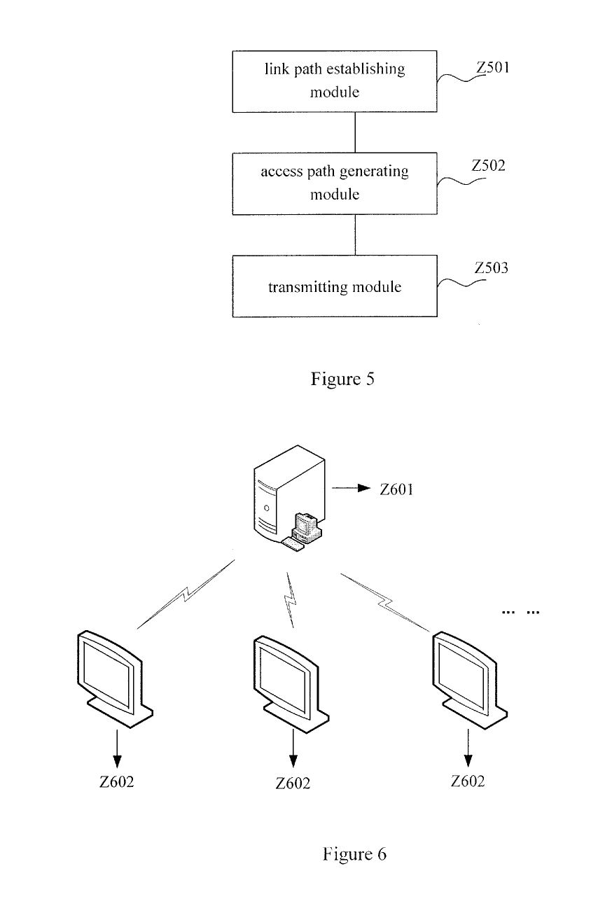

There is also provided a cloud server in another embodiment of the present disclosure. As shown in FIG. 5, the cloud server includes: a link path establishing module Z501 for establishing a link path for a digital television according to an access request to access an OSD subject file library received from the digital television; an access path generating module Z502 for generating an access path for each OSD subject file selected by the digital television according to an OSD subject file selecting instruction transmitted from the digital television through the link path; and a transmitting module Z503 for transmitting the access paths to the digital television through the link path so as to instruct the digital television to obtain the selected OSD subject file based on the access paths.

The cloud server provided in the present embodiment enables the digital television to update the OSD subject file in real time.

Furthermore, as shown in FIG. 6, there is also provided an OSD subject file updating system in another embodiment of the present disclosure, which includes at least one cloud server Z601 and at least one digital television Z602, wherein the cloud server Z601 is the cloud server as provided in the above embodiments and the digital television Z602 is the digital television as provided in the above embodiments.

In a summary, according to the OSD subject file obtaining method and providing method, the digital television, the cloud sever and the OSD subject file updating system provided in the embodiments of the present disclosure, in the case that the digital television is on-line, when it is determined that the OSD subject file needs to be obtained, the digital television obtains the selected OSD subject file in real time by accessing the OSD subject file library of the could server, so as to update the OSD subject file immediately, or store the selected OSD subject file which has been obtained. Therefore, the OSD subject file can also be updated in real time even if the digital television is off-line, which further makes the digital television update the OSD subject file in real time, thereby improving the users' experience.

The present disclosure is described by referring to the flowcharts and/or block diagrams of the method, devices (systems) and computer program products according to the embodiments of the present disclosure. It should be understood that every process and/or block in the flowcharts and/or block diagrams and a combination of the processes and/or blocks in the flowcharts and/or block diagrams can be realized by computer program instructions. These computer program instructions may be provided to a general purpose computer, a special purpose computer, a embedded processor or a processor of other programmable data processing devices to produce a machine, such that the instructions executed by a computer or a processor of other programmable data processing devices generate means for realizing the functions specified in one process or multiple processes of the flowcharts and/or in one block or multiple blocks of the block diagrams.

These computer program instructions may also be stored in a computer-readable memory which can instruct a computer or other programmable data processing devices to operate in a particular way, such that the instructions stored in the computer-readable memory generate manufacture products including instruction means which realize the functions specified in one process or multiple processes of the flowcharts and/or in one block or multiple blocks of the block diagrams.

These computer program instructions may also be loaded onto a computer or other programmable data processing devices, such that a series of steps are implemented on the computer or other programmable devices to generate a computer implemented process, thereby the instructions executed on a computer or other programmable devices provide steps for realizing the functions specified in one process or multiple processes of the flowcharts and/or in one block or multiple blocks of the block diagrams.

Obviously, those skilled in the art may make various modifications and variations to the present disclosure without departing from the spirit and scope of the present disclosure. As such, if such modifications and variations of the present disclosure belong to the technical scope of the claims of the present disclosure and their equivalents, these modifications and variations are also intended to be incorporated within the protection scope of the present disclosure.

The present application claims the priority of Chinese Patent Application No. 201410318722.1 filed on Jul. 4, 2014, the entire content of which is incorporated as part of the present disclosure by reference.

1. A method for obtaining an On-Screen Display (OSD) subject file, comprising:
transmitting, by a digital television, to a cloud server a request instruction to access an OSD subject file library;
accessing, by the digital television, the OSD subject file library on the cloud server through a link path established for the digital television by the cloud server according to the request instruction;
selecting, by the digital television, at least one OSD subject file from the OSD subject file library; and
obtaining, by the digital television, the OSD subject file selected by the digital television based on access path generated by the cloud server for each OSD subject file selected by the digital television.

2. The method according to claim 1, wherein the digital television comprises a master and a remote controller, and said transmitting, by a digital television, to a cloud server a request instruction to access an OSD subject file library comprises:
the master receiving an instruction to obtain the OSD subject file transmitted by the remote controller; and
the master transmitting the request instruction to access the OSD subject file library to the cloud server in response to the instruction to obtain the OSD subject file.

3. The method according to claim 1, wherein the digital television comprises a master and a remote controller, and said selecting, by the digital television, at least one OSD subject file from the OSD subject file library comprises:
the master receiving a determination instruction transmitted from the remote controller; and
the master transmitting a message for selecting the at least one OSD subject file from the OSD subject file library to the cloud server according to the determination instruction.

4. The method according to claim 1, said obtaining, by the digital television, the OSD subject file selected by the digital television based on the access path generated by the cloud server for each OSD subject file selected by the digital television comprises:
downloading, by the digital television, the OSD subject file through the access path generated by the cloud server for each OSD subject file selected by the digital television; and
storing the downloaded OSD subject file to the digital television itself or to a storage device connected to the digital television.

5. The method according to claim 4, wherein the digital television comprises a master and a remote controller, and said storing the downloaded OSD subject file to the digital television itself or to the storage device connected to the digital television comprises:
the master receiving a storage instruction transmitted from the remote controller;
the master storing the downloaded OSD subject file locally or to the storage device connected to the master according to the storage instruction.

6. The method according to claim 5, further comprising:
receiving, by the master, an OSD subject file browsing instruction transmitted from the remote controller and browsing the OSD subject files stored locally or in the storage device connected to the master according to the OSD subject file browsing instruction; and
receiving, by the master, an OSD subject file updating instruction, selecting an OSD subject file to be updated from the OSD subject files stored locally or in the storage device connected to the master according to the OSD subject file updating instruction, and using the OSD subject file to be updated as a current OSD subject file of the digital television.

7. A method for providing an OSD subject file, comprising:
establishing, by a cloud server, a link path for a digital television according to an access request to access an OSD subject file library received from the digital television;
generating, by the cloud server, a access path for each OSD subject file selected by the digital television according to an OSD subject file selecting instruction transmitted from the digital television through the link path;
transmitting, by the cloud server, the access path to the digital television through the link path, so as to instruct the digital television to obtain the selected OSD subject files based on the access path.

8. A digital television, a master of which comprises:
a requesting module, configured to transmit to a cloud server a request instruction to access an OSD subject file library;
an accessing module, configured to access the OSD subject file library on the cloud server through a link path established for the digital television by the cloud server according to the request instruction;
a selecting module, configured to select at least one OSD subject file from the OSD subject file library; and
an obtaining module, configured to obtain the selected OSD subject file based on access path generated by the cloud server for each selected OSD subject file.

9. The digital television according to claim 8, further comprising a remote controller, wherein the remote controller is configured to transmit an instruction to obtain the OSD subject file to the master, and
the requesting module is particularly configured to:
receive the instruction to obtain the OSD subject file transmitted by the remote controller; and
transmit the request instruction to access the OSD subject file library to the cloud server in response to the instruction to obtain the OSD subject file.

10. The digital television according to claim 8, further comprising a remote controller, wherein the remote controller is configured to transmit, to the master, a determination instruction to instruct the master to transmit, to the cloud server, a message for selecting at least one OSD subject file from the OSD subject file library, and
the selecting module is particularly configured to:
receive the determination instruction transmitted from the remote controller; and
transmit the message for selecting the at least one OSD subject file from the OSD subject file library to the cloud server according to the determination instruction.

11. The digital television according to claim 8, the obtaining module is particularly configured to:
download the OSD subject file based on the access path generated by the cloud server for each OSD subject file selected by the digital television; and
store the downloaded OSD subject file locally to the master or to a storage device connected to the master.

12. The digital television according to claim 11, further comprising a remote controller, wherein the remote controller is configured to transmit to the master a storage instruction for instructing the master to store the downloaded OSD subject file locally to the master or to a storage device connected to the master; and
the obtaining module, when storing the downloaded OSD subject file locally to the master or to the storage device connected to the master, is in particular configured to:
receive the storage instruction transmitted from the remote controller; and
store the downloaded OSD subject file locally to the master or to the storage device connected to the master according to the storage instruction.

13. The digital television according to claim 11, further comprising a remote controller, wherein the remote controller is configured to transmit to the master an OSD subject file browsing instruction and an OSD subject file updating instruction,
wherein the master further comprises an updating module which is configured to:
receive the OSD subject file browsing instruction transmitted from the remote controller and browsing the OSD subject files stored locally in the master or in the storage device connected to the master according to the OSD subject file browsing instruction; and
receive the OSD subject file updating instruction transmitted from the remote controller, selecting a OSD subject file to be updated from the OSD subject files stored locally in the master or in the storage device connected to the master according to the OSD subject file updating instruction, and using the OSD subject file to be updated as a current OSD subject file of the digital television.

14. (canceled)

15. (canceled)
